(19) United States
(12) Patent Application Publication
(10) Pub. No.: US 2003/0168754 A1
(43) Pub. Date: Sep. 11, 2003

(54) Method and arrangement for introducing gas into liquids by means of a novel mixer

(76) Inventors: Pasquale Spiegel, Glinde (DE); Margret Spiegel, Glinde (DE)

Correspondence Address: HENRY M FEIEREISEN, LLC, 350 FIFTH AVENUE, SUITE 4714, NEW YORK, NY, 10118, US

(21) Appl. No.: 10/404,470

(22) Filed: Apr. 1, 2003

Related U.S. Application Data
(63) Continuation of application No. 09/831,256, filed on May 8, 2001, now abandoned.
Application No. 09/831,256 is a 371 of international application No. PCT/DE99/03559, filed on Nov. 8, 1999.

(30) Foreign Application Priority Data
Nov. 8, 1998 (DE) 198 51 360.7

(51) Int. Cl. B01F 3/04

(52) U.S. Cl. 261/94; 261/DIG. 7

(57) ABSTRACT

The method provides for introducing gas, preferably CO₂, into a liquid by means of a mixer. The arrangement includes a mixer (2), which is comprised of several mixing elements. Gas and liquid are mixed by the mixing elements. The individual mixing elements may have different sizes depending on the task at hand.

### CROSS-REFERENCES TO RELATED APPLICATIONS

This application claims the priority of German Patent Application Serial No. 198 51 360.1, filed Nov. 8, 1998, pursuant to 35 U.S.C. 119(a)-(d), the disclosure of which is incorporated herein by reference and the priority of International application PCT/DE 99/03559 filed Nov. 8, 1999.

This application claims the benefit pursuant to 35 U.S.C. 120, of prior filed copending U.S. application Ser. No. 09/831,256 filed May 8, 2001, now abandoned, the disclosure of which is incorporated herein by reference;

This application a continuation-in-part of prior filed copending U.S. application Ser. No. 10/334,187 filed Dec. 30, 2002, the disclosure of which is incorporated herein by reference.

### BACKGROUND OF THE INVENTION

The invention relates to a novel mixer by which gas is introduced into liquids, preferably CO₂, in water.

The invention further relates to an arrangement and a construction of the novel mixer. Beverages, in particular water and mineral water, but also refreshments such as lemonade, fruit juices and liquids mixed with other flavoring agents are carbonized, i.e., mixed with CO₂ (carbon dioxide) to produce the impression of freshness that is currently so desired. Addition of CO₂ can also improve stale or flat water or water mixed with disinfectants. Therefore, CO₂ is added to water (with or without mineral agents) in bottles or other containers and introduced under pressure into liquids and, e.g., dispensed from so-called CO₂ cartridges. The purchase of carbonated water in bottle is complex and expensive in view of the transports. The do-it-yourself preparation is also complicated as the CO₂ gas in pressure containers has to be introduced into the water, which then remains under pressure in the containers.

### SUMMARY OF THE INVENTION

The invention is based on the object to provide a novel mixer by which carbonated liquids, in particular water, can easily be produced continuously, whereby the CO₂ consumption depends on the amount of supplied and tapped water.

The invention is attained by conducting the gas to flowing liquid and by using the novel mixer for attaining and optimum mixture.

According to a further embodiment of the invention, which has separate inventive status, for absorbing CO₂ and other gases, the novel mixture implements a very high mixing quality (carbonization) at slight pressure conditions of liquids and gas.

According to a further embodiment of the invention, which also has separate inventive status, the novel mixer is in a position to realize a constant quality, for example, soda water, provided that the water stream to the mixer is not interrupted and the gas supply CO₂ is also ongoing in this case, whereby the novel mixer runs better than all known systems which require very high pressure for the production of carbonated water.

A further embodiment of the invention, which also has separate inventive status, realizes without any problem that the novel mixer creates a bottle quality of, for example, soda water. When referring to bottle quality, the inventor of the mixer means commercially available bottles filled with soda water.

A further embodiment of the invention, which also has separate inventive status, resides in the fact that the main field of application of the novel mixer can be seen in conjunction with a spigot or mixing faucet, for example one-hand mixing faucets or two-hand mixing faucets with at least one cold water supply. This fitting to tap soda water (spigot) is so constructed as to allow tapping of normal cold or warm water, mixed water, and by way of a separate shut-off valve very high-quality soda water, which is provided at the fitting. Detailed information with respect to this example is referred to in applications filed with the Patent Office. These applications also refer to the use of retrofitting dispensers for water to allow tapping of soda water from conventional spigots or mixing faucets.

In accordance with a further embodiment of the invention, which also has separate inventive status, the novel mixer is utilized to make also refreshments. In this case, an automatic vending machine may be involved having at least one cold water supply. The novel mixer is fed in this case with water and CO₂, and after circulation of water and CO₂ through the mixer a high carbonization is realized. After this mixing process, flavoring agents must be added. This may be implemented incrementally or continuously. This example for the field of application of the novel mixer may also be exploited for alcoholic beverages. It may be used for private households or industrial application.

In accordance with a further embodiment of the invention, which also has separate inventive status, the novel SLS-mixer is used in agriculture and gardening by using water, carbonized by the mixer, for fertilization and watering of fields and greenhouses.

A further embodiment of the invention, which also has separate inventive status, resides in the field of application in cleaning machines (carpet cleaning machines). The mixer is integrated downstream of a pump which is connected to a reservoir. Connected upstream of the mixer is the CO₂ introduction; thus, carbonated water can be produced for the carpet cleaning.

According to a further embodiment of the invention, which also has separate inventive status, the novel mixer is integrated in a washing machine. These washing machines may be industrial or household washing machines. Water required for the washing process is conducted together with CO₂ through the mixer into the washing machine.

A further embodiment of the invention, which also has separate inventive status, resides in the structure and the configuration of the SLS-mixer. The novel mixer is comprised of individual mixing screens, which abut one another depending on the field of application. The number of mixing screens and the diameter as well as strength thereof depends on the task of the mixer at hand. This relates also to the mesh structure (throughput rate) of the mesh. Preferred materials include VA-steel or plastics. The same effect could be attained with metal disks or plastic disks having corresponding boreholes and same arrangement as in the screens.

According to a further development of the invention, which also has separate inventive status, the mixer is comprised of one or more parts and is identical or of similar configuration as the mixer described previously by me. Gas and liquids can be mixed in a same quality with this mixer as with the afore-described mixer.

According to a further advantageous configuration of the invention, which also has separate inventive status, the novel mixer mixes in the high temperature fluctuation range of water always at a same quality of soda water or other beverages. Also the extremely small bubble formation of carbonic acid, generated by this mixer in soda water and other refreshments, tastes extremely pleasant. The high carbonization is characterized by the fact that the bound CO₂ in water has small losses of unbound CO₂ after the mixing process. The release of CO₂ is very low compared to other methods that carbonize water. This new type of mixer exhibits superior properties to produce quality soda water with little pressure.

A further embodiment of the invention, which also has separate inventive status resides in the fact that the novel mixer can be made highly cost-efficient and that this mixer operates at slight counter pressure to hereby realize a calm flow behavior of the gas to be mixed with the liquid.

According to a further development of the invention, which also has separate inventive status, the mixer may be comprised of spherical, conical or cylindrical components, which are connected in a construction frame. These components can be mixing elements of spherical or conical configuration; or spherical and cylindrical configuration; or spherical, conical and cylindrical configuration. These mixing elements are stabilized by a respective frame. Any of the afore-described mixing elements of spherical, conical and cylindrical configuration that comprise the mixer are be placed at random distribution in a frame sitting in the mixer housing.

According to a further development of the invention, which also has separate inventive status, the novel mixer is placed in a tube, which has at the same time a connection for the liquid stream and the gas introduction. The tube has further a connection possibility for a metering station downstream of the mixing process of liquids and gas. This may also take place upstream of the mixer. One or more attachments are integrated in the tube for securement of the mixer. At the same time, the tube is so sized as to allow exploitation of the tube as reaction time. The connection for the liquid and gas supplies can also be configured as detachable connection.

The novel mixer can also be in a housing of a shape other than a tube and there are no-limitations as to any shape of the housing for the mixer, and the housing can be of a shape suitable to the spatial requirements of the mixer assembly.

According to a further advantageous configuration of the invention, which also has separate inventive status, the connection possibility for a gas container (CO₂) is so constructed that a line from the tube where the mixer is installed has a connection possibility to attach a gas container without any problem. This connection from tube to container may be flexible. The connection for the gas container is so constructed that only a licensed gas container can be attached to the tube for supply of gas to the mixer.

According to a further advantageous configuration of the invention, which also has separate inventive status, the mixer is so constructed as to suit the field of application. The fact that there is a fixed setting of liquids and the respective gas means with respect to the liquids the flow rate and the liquid pressure at the gas, the volume flow amount and the gas pressure. The afore-stated conditions are ensured by pressure reducers and volume flow-valves. An optimum quality is ensured as a result of the fixed setting of the pressure as well as the volume flow of the liquid and the gas. The mixer can also be used reliably in situations, where no fixed setting is required.

The invention is not only directed to carbonization of water of any type. The novel mixer can be used for all conceivable liquids and gas types.

### BRIEF DESCRIPTION OF THE DRAWINGS

The following figures depict certain illustrative embodiments of the invention in which like reference numerals refer to like elements. These depicted embodiments are to be understood as illustrative of the invention and not as limiting in any way.

The above and other objects, features and advantages of the present invention will now be described in more detail with reference to the accompanying drawing in which:

FIG. 1 shows a top view of single mixing screen;

FIG. 2 shows a side view of a first embodiment of a complete mixer comprised of individual screens;

FIG. 3 shows a side view section of a mixer assembly in one piece and showing the individual screens, as well as the connection ports for the supply with liquids and gas;

FIG. 4 shows a mixer comprised of individual mixing screens showing connection ports for gas and liquids, attachment points for the mixer and feed ports for flavoring agents.

FIG. 5 shows a cross section of a second embodiment of a mixer according to the invention with spherical mixing elements

FIG. 6 shows a longitudinal section along line B-B of the mixer in FIG.5;

FIG. 7 shows a cross section of a mixer with conical mixing elements;

FIG. 8 shows a longitudinal section along line D-D of the mixer in FIG. 7;

FIG. 9 shows a cross section along line E-E of a mixer with cylindrical mixing elements of FIG. 10;

FIG. 10 shows a longitudinal section of the mixer of FIG. 5 with cylindrical mixing elements;

FIG. 11 shows a cross section of a mixer with mixing elements of varying shape and size;

FIG. 12 shows a longitudinal section along line H-H of the mixer in FIG. 11;

FIG. 13 shows a cross section of a mixer with mixing elements of various spherical sizes;

FIG. 14 shows a longitudinal section along line J-J of the mixer in FIG. 13;

FIG. 15 shows a cross section of a mixer with uniformly shaped mixing elements;

FIG. 16 shows a longitudinal section along line L-L of the mixer in FIG. 15;

FIG. 17 shows a mixing assembly connected to a water line under a kitchen counter; and

FIG. 18 shows an example of the use of the mixing assembly for a horticultural set-up.

### DETAILED DESCRIPTION OF CERTAIN ILLUSTRATED EMBODIMENTS

Throughout all the Figures, same or corresponding elements are generally indicated by same reference numerals.

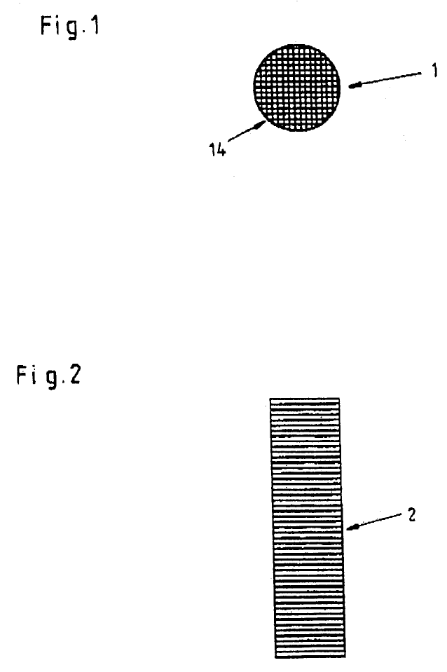

Turning now to the drawing, and in particular to FIGS. 1 and 2 there is shown a top view of a single mixing screen (1) and the composition of the meshes (14). By changing the meshes (14), an optimum mixture of the respective liquids (4) and gases (13) can be achieved. This relates, of course, to the complete mixer (2) shown in FIG. 2.

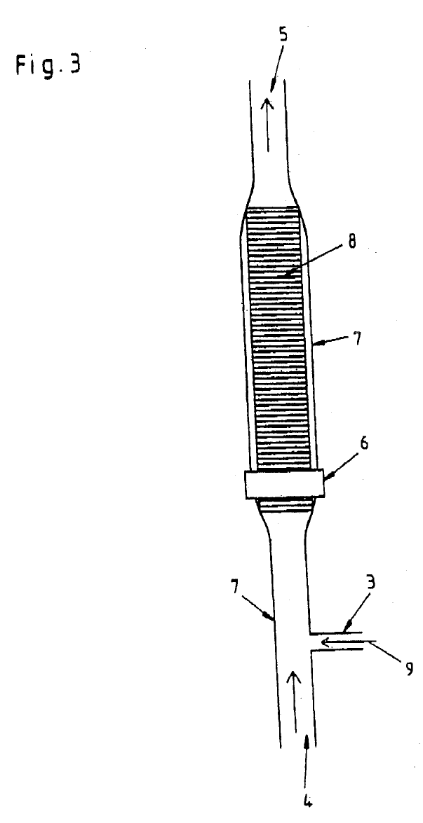

FIG. 3 shows a schematic drawing of a complete mixer (8) which is made in one piece and inserted in a tube (7) which has separate connection possibilities, i.e. ports (6) for gas (13) supply and the liquid (4) supply. FIG. 3 shows further the exit ports and connection ports for integration of the mixer (2) (8) to a respective mixer assembly or mixer systems.

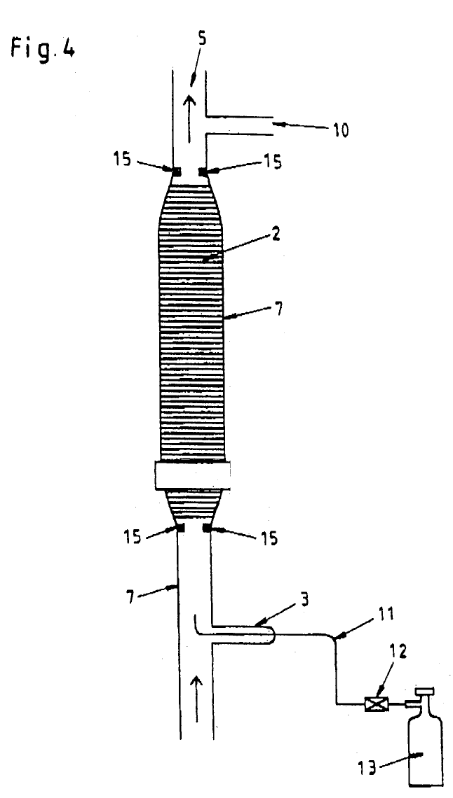

FIG. 4 shows a mixer (2), which is composed of individual mixing screens (1). The drawing further shows the tube (7) with integrated connection ports for gas (13) liquids (4), gas line (11), gas container (13), connection (12) for the gas container, attachment points (15) for the mixer (2), feed possibility for flavoring agents (10), exit possibility for mixed liquids (4), with gas (13). At the same time, this exit (5) is provided for the attachment to the desired field of use of the mixer (2), and moreover the exit possibility may be exploited with respect to the tube (7) length as reaction time for the mixed materials.

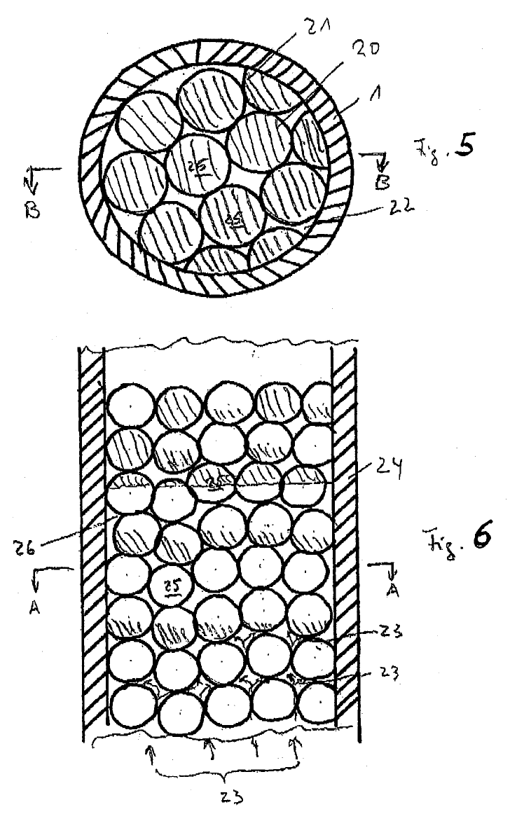

In FIG. 5 the mixer is shown in cross section. The housing (1) of the mixer is configured in the shape of a tube. Within the tube are the mixing elements 20, which partially adjoin each other by their surfaces. Between the surfaces 21 of adjoining mixing elements 20 are spacings 22 for flow-through of the gas-liquid mixture, which forms immediately after inletting of the gas 13 into the liquid 4. The tube 7 is provided with a frame 24 for carrying the mixing elements 20.

In FIG. 6 the tubular frame 24 is shown with a mixer of spherical mixing elements 25. The spherical mixing elements 25 are surrounded by the inflowing gas/liquid stream, which flows from the bottom to the top, whereby the gas/liquid mixture 23 is re-routed in multiple ways. These re-routed partial gas/liquid streams after flowing around each of the mixing elements 20, then recombine in multiple paths, thereby effecting additional mixing. Conveniently, the mixing elements 20 are arranged in the mixer at a random distribution 26 inside the tubular frame 24. Accordingly, the spherical mixing elements 25 are not specifically ordered in rows or such, but are arranged in random distribution 26.

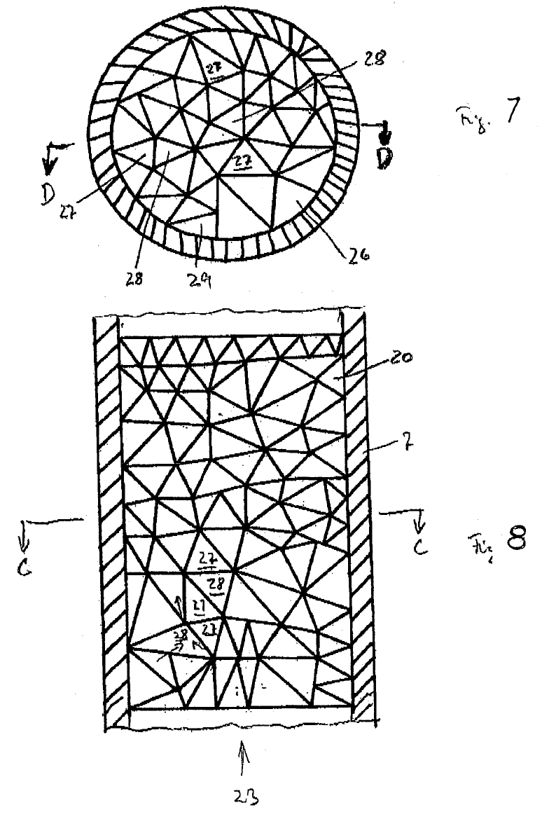

FIG. 7 shows the mixing elements 20 configured as cones 27 as part of the mixer. These cones are likewise arranged in a random distribution 26 and thus include the spacings 28, which are filled by the gas-liquid mixture 23 during the flow of the gas-liquid mixture through tube 7. Depending on the configuration of the cones 27 and their position relative to each other within the interior 29 of the tube 7, the gas-liquid mixture 23 flows in a multitude of streams that are re-routed and divided into partial streams through interior space 29, thereby effecting a thorough mixing of the gas 13 component with the liquid component 4, so that at the outlet port 5 of the frame 24, a stabilized soda water can be tapped.

FIG. 8 shows the adjoining conical spacings 28 in the mixer corresponding to the respective conical shape mixing elements 27 in the mixer. Depending on the position of the cones 27 relative to each other and the spacings 28 as a result of their distribution 26, the gas-liquid mixture 23 flow through the frame 24 is diverted in multiple ways. In particular, at the points and the edges of the conical shape mixing elements 20 an intensive mixing of the gas-liquid mixture 23 is realized so that a stabilized soda water becomes available at outlet port 5.

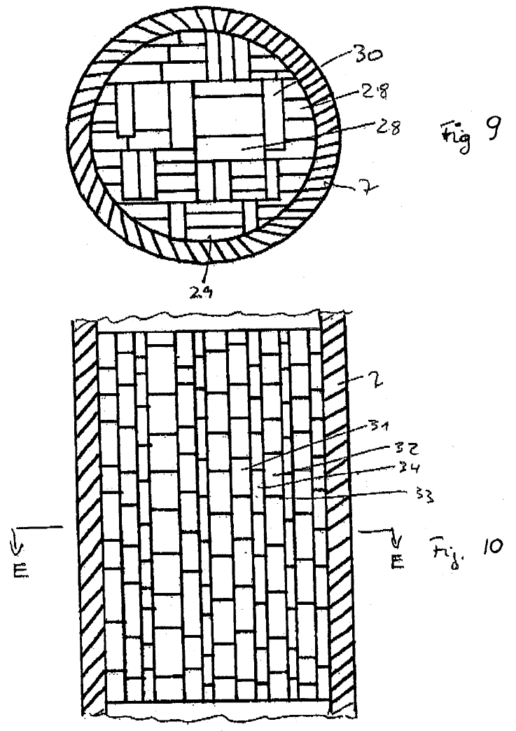

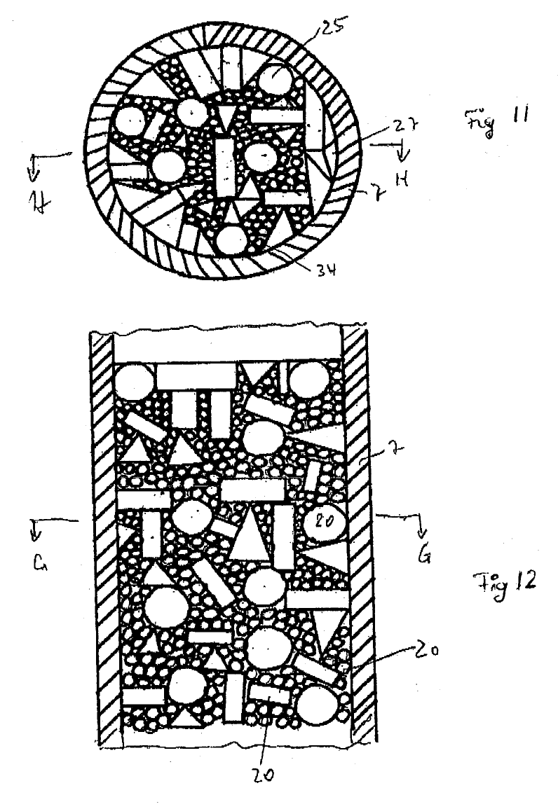

FIG. 9 shows a cross section corresponding to the line E-E in FIG. 8. The interior space 29 surrounded by tube 7 contains a distribution 26 of cylindrical mixing elements 30. Likewise, in this random distribution 26, the cylindrical mixing elements 30 are adjoining one another with spacings 28 between them, which oftentimes also have cylindrical-shaped cross sections. On the other hand, cylindrical mixing elements 30 are present which are not positioned in one plane, and exhibit a random distribution. Thus, some of the cylindrical mixing elements are positioned only partially in a horizontal plane, for example those which point downward from the plane as shown in FIGS. 8 and 9, while the other part of the mixing element is lying outside the cross sectional plane. This is also evident from the longitudinal section as shown in FIG. 10. There, two of the mixing elements 31, 32 terminate at the same plane 33, while between the two mixing elements 31, 32 a mixing element 34 is positioned with its section surface within the section plane 33.

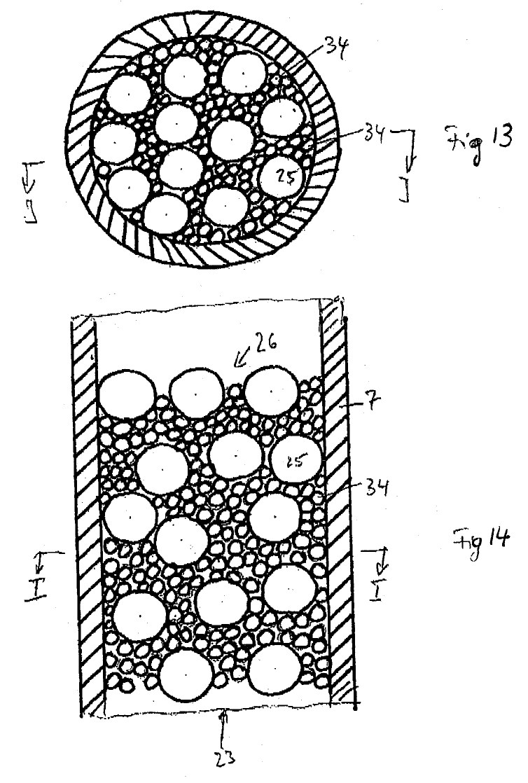

In another variation of the invention, a combination of two or more differently shaped mixing elements is also conceivable. Such a combination is for example shown in FIGS. 11 and 12, wherein FIG. 11 shows a cross section of the tube 7 of FIG. 12. From FIG. 11 it is evident that when mixing elements 20 are utilized a particularly intensive mixture of the gas-fluid mixture 23 is realized. The gas-fluid mixture 23 flowing through tube 7 at a constant pressure is redirected around the numerous edges of the small spheres 34 to a greater degree, than when mixing elements 20 are of a larger size, for example mixing elements 20 configured as cones 27. When these mixing elements 20 are of varying size, a particularly intense mixing of the gas-liquid mixture 23 is realized.

FIG. 12 is a longitudinal section along line HH. This illustrates likewise that the mixing elements 20 of varying size and configuration causes flow patterns that lead to an intensive mixing of mixing component gas 13 and mixing component fluid 4.

FIG. 13 shows the uneven distribution of big spheres within a mixture of relatively small spherical mixing elements particularly suitable for mixing of gas-fluid mixtures 23 with a relatively small flow volume, but which flows through tube 7 in rather fast manner. As a result, in the area near the larger spheres 25, quieter flow zones are created. Accordingly, the flow, which quiets down in the area of the large spheres 25, when entering an area of the smaller spheres is again subject to acceleration. In this way, repeated acceleration and slow-down of the flow of the gas-fluid mixture 23 generates additional swirling effects, by which a particularly well mixed soda water is realized.

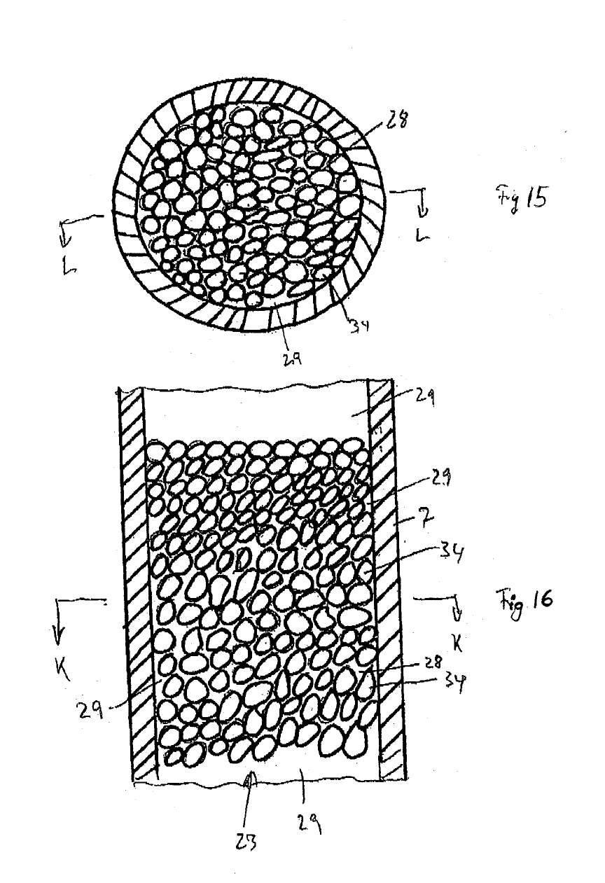

From FIG. 14, it becomes particularly evident how the slowing down-phases and the acceleration phases are unevenly distributed along the entire length of the tube 7. In this way, a good mixing of small amounts of the gas-fluid mixture 23 is realized, which is of particular importance when used in conjunction with household appliances. With respect to the variation in water quality in larger cities, there is the favorable effect that the deposit of calcium is prevented through the control of acceleration and slow-down of the gas-fluid mixture 23.

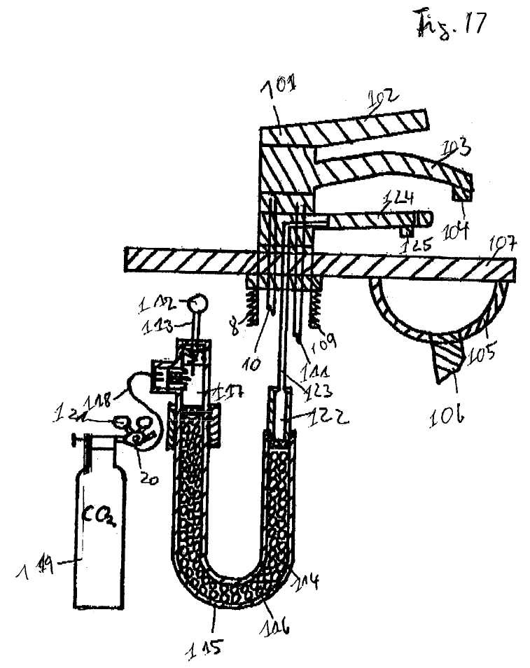

In FIG. 15 a tube 7 shown in cross section is filled exclusively with small spheres 34, so that only small spacings 28 exist between the mixing elements. In these small spacings 28 relatively small amounts of gas-fluid mixture 23 are being intensively redirected and thereby mixed. This type of filling is therefore suitable for a comparatively small amount of flow volume.

In FIG. 16, the effects of a particularly tight distribution of the mixing elements is shown. Only small spacings 28 are seen between the comparatively small spherical mixing elements 34, through which the gas-fluid mixture 23 must flow. Accordingly, intense redirection of the gas-fluid mixture flow takes place among the mixing elements 20, so that this type distribution 26 with small spherical mixing elements 34 is particle effective when there is a small amount of flow volume.

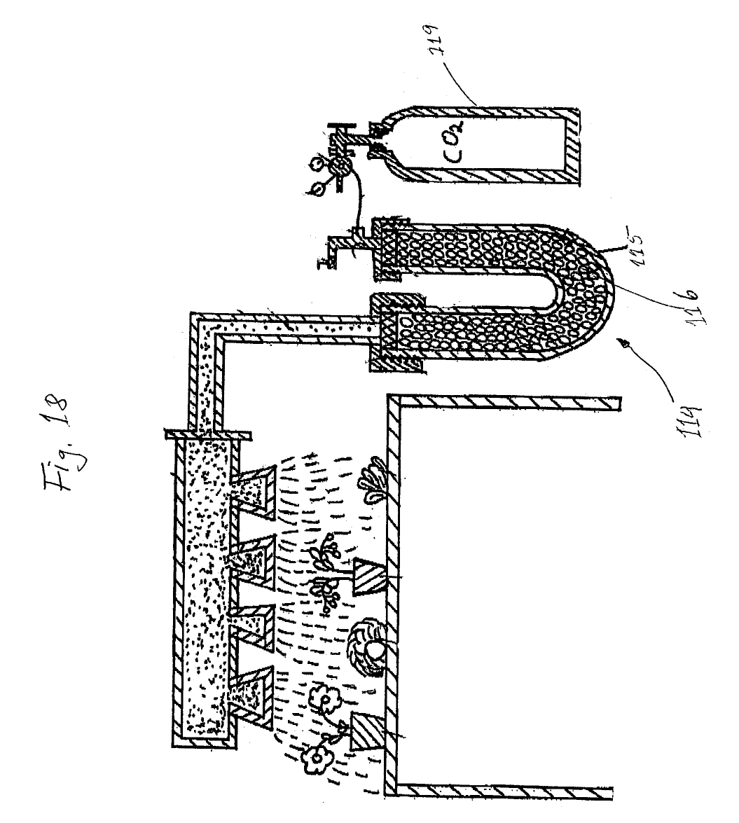

FIG. 17 shows a mixing faucet assembly for a kitchen installation, showing mixing faucet 1 comprising a hand lever 2 for up and down movement in a vertical plane to thereby open the water supply to a tap 3, at which water can, be drawn through spigot 4 in the direction of water basin 5 when hand lever 2 is moved upward. From water basin 5, the water can flow through drain 6. The water basin is attached to a kitchen counter 7 seen here only in partial representation.

In FIG. 17 the kitchen installation incorporating the mixer of the afore-described type is shown. Mixing faucet 101 is attached to the kitchen counter 107 for example by screws 108, 109. Both, a supply line for cold water 110 and a supply line for warm water 111 extend through the kitchen counter 107. The supply lines are connected to the general water network by means not shown here.

The supply line 112 is likewise connected to the general water network and is connected via a respective line 113 to mixer 114, here seen as configured in the form of U-shaped pipe 115 which is filled with mixing elements 116. Water supply line 113 terminates in the supply side 117 of U-shaped pipe 115. Furthermore, a gas connection 118 coming for example from a CO₂ gas bottle also terminates in the supply line 117. At the terminal where the gas connection 118 terminates into the gas container 119, a pressure-reducing unit 120 is provided for controlling the gas pressure and keeping it at a constant level. The adjustment of the gas pressure is carried out by means of a gas pressure gauge 121, which measures on the one hand the pressure in the gas container 119, and on the other hand measures the gas pressure within the gas connection 118, after the gas has left the gas container 1 19. The U-shaped pipe 115 has a drain side 122 opposite the supply side 117, which is connected to the mixed water tap 124 via a mixing pipe 123. This mixing tap 124 can be controlled independently of hand lever 102 of mixing battery 101 and thereby allows tapping of CO₂ Water from the opening 125.

While the invention has been illustrated and described as embodied in a gas-liquid mixer, it is not intended to be limited to the details shown since various modifications and structural changes may be made without departing in any way from the spirit of the present invention.

What is claimed as new and desired to be protected by Letters Patent is set forth in the appended claims:

What is claimed is:

1. A method for mixing gas and liquids through a mixer, the method comprising the steps of:
providing a mixer within a housing, the mixer including mixing elements of a shape selected from the group consisting of spherical, conical and cylindrical shape;
supplying a gas via a gas line to the mixer, and
supplying a liquid via a liquid line to the mixer thereby forming a gas/liquid stream throughout the mixer; and wherein the gas/liquid stream when brought in contact with the mixing elements are deflected from surfaces of the mixing elements and thereby thoroughly mixed.

2. The method of claim 1, wherein the housing has a cylindrical shape.

3. The method of claim 1, wherein the gas is CO₂.

4. The method of claim 1, wherein the liquid is water.

5. The method of claim 1, wherein the housing is configured as a frame.

6. Method according to claim 1, further comprising the step of cooling the liquid before supplying it to the mixer.

7. A device for mixing gas and liquids comprising:
a cylindrical tube;
a mixer disposed in the tube, the mixer including mixing elements;
wherein the mixing elements are held in the tube;
a gas supply line and a liquid supply line for supply of gas and water into the mixer; and wherein the mixing elements provide rebounding surfaces for a gas/liquid stream formed when the gas and liquid are supplied to the mixer, whereby the gas and liquid are thoroughly mixed when rebounded from the surfaces of the mixing elements.

8. The device of claim 7, wherein the mixing elements are configured in the shape selected from the group consisting of spherical, conical or cylindrical shape.

9. The device of claim 7, wherein the mixing elements having a spherical shape.

10. The device of claim 7, wherein the mixing elements having a conical shape.

11. The device of claim 7, wherein the mixing elements having a cylindrical shape.

12. The device of claim 7, wherein the mixing elements are randomly positioned in the mixer.

13. The device of claim 7, wherein the mixing elements are within a frame.

14. An arrangement for use of carbonated water in agriculture or gardening comprising:
a housing having a an inlet end and an outlet end;
a mixer disposed in the housing; the mixer including mixing elements;
a gas supply line and a liquid supply line for supply of gas and water into the mixer; and wherein the mixing elements provide rebounding surfaces for a gas/liquid stream formed when the gas and liquid are supplied to the mixer, whereby the gas and liquid are thoroughly mixed when rebounded from the surfaces of the mixing;
a distribution line coupled to the housing and extending in longitudinal direction, wherein the distribution line including a plurality of openings positioned along its longitudinal extension for releasing a thoroughly mixed gas/liquid mixture.

15. The arrangement of claim 14, wherein the housing is U-shaped.

16. The arrangement of claim 14, wherein the mixing elements are configured in a shape selected from the group consisting of conical, cylindrical and spherical shape.
